(19) United States
(12) Patent Application Publication
(10) Pub. No.: US 2026/0054219 A1
(43) Pub. Date: Feb. 26, 2026

(54) PASSIVE AND FORCED SYNTHESIS OF MG(OH)2 FOR THE PURPOSE OF SUPPLYING MAGNESIUM-BASED CAPTURE OF CO2

(71) Applicant: CARBONFREE CHEMICALS HOLDINGS, LLC, San Antonio, TX (US)

(72) Inventor: Joe JONES, San Antonio, TX (US)

(73) Assignee: CARBONFREE CHEMICALS HOLDINGS, LLC, San Antonio, TX (US)

(21) Appl. No.: 19/106,072

(22) PCT Filed: Aug. 24, 2023
(86) PCT No.: PCT/US2023/072825

§ 371 Date: Feb. 24, 2025

Related U.S. Application Data
(60) Provisional application No. 63/400,604, filed on Aug. 24, 2022.

(51) Int. Cl. B01D 53/82; B01D 53/62; C01F 5/14; C01F 5/30; C01F 11/18; C01F 11/24

(52) U.S. Cl. CPC B01D 53/82; B01D 53/62; C01F 5/14; C01F 5/30; C01F 11/18; C01F 11/24; B01D 2251/402; B01D 2251/604; B01D 2258/0283

(57) ABSTRACT

The present invention relates to a method for capturing carbon dioxide and sequestering the carbon dioxide as calcium carbonate. The method involves the use of an aqueous solution of magnesium hydroxide as a carbon dioxide uptake fluid. The magnesium hydroxide in the uptake fluid is produced by two distinct pathways. a forced decomposition pathway and a passive dissolution pathway. The combined use of the forced decomposition and passive dissolution pathways is a significant contributing factor to the low energy penalty of the carbon dioxide capture and sequestration method.

### CROSS-REFERENCE TO RELATED APPLICATIONS

This application claims the benefit of priority to U.S. Provisional Patent Application Ser. No. 63/400,604, filed Aug. 24, 2022, hereby incorporated by reference in its entirety.

### FIELD OF THE INVENTION

The invention relates generally to methods for capture and sequestration of carbon dioxide.

### BACKGROUND

The vast majority of US and global energy use is based on combustion of non-renewable fossil fuels, which results in the emission of carbon dioxide (CO2) into the atmosphere. The persistent and ever-increasing release of carbon dioxide into the atmosphere has been shown to have a negative effect on climate. Earth's temperature has risen by 0.14° F. (0.08° C.) per decade since 1880, but the rate of warming since 1981 has more than doubled to 0.32° F. (0.18° C.) per decade. The nine years from 2013 through 2021 rank among the 10 warmest years on record. Although many alternatives to combustion are being considered, the fact is that combustion will remain a principal component of the global energy system for decades to come.

Energy-efficient and scalable carbon dioxide capture stands as one of the greatest challenges for modern energy researchers. The idea of separating carbon dioxide from flue gas began as a means for recovering economically valuable carbon dioxide for enhanced oil recovery. The power industry explored the use of different chemical sorbents and found that monoethanolamine was a functional capture agent. Carbon dioxide capture using amines was evaluated as an early technology and was deemed to be unacceptable due to material cost and high energy penalty. The technology has since improved; however, it is still plagued by high costs and inefficiency.

The effects of continued carbon dioxide discharge into the atmosphere remains one of the most vexing problems facing humanity. Existing carbon capture technologies are expensive and energy-intensive, and new developments will be needed to increase efficiency and attract investors. There exists a need in the industry for energy-efficient and carbon-negative methods to capture carbon dioxide.

### SUMMARY

Alkaline solutions, e.g., monoethanolamine solutions, act as sinks for the capture of carbon dioxide and have been the focus of many emission-reduction studies. An aqueous solution of magnesium hydroxide, for example, is an alkaline solution that can capture gaseous carbon dioxide and sequester it in the form of a magnesium carbonate salt. Based upon this principle, the present inventor has devised a hybrid carbon dioxide capture and sequestration method that employs two distinct pathways for generating the carbon dioxide-capturing agent, magnesium hydroxide. The two distinct pathways include a forced decomposition pathway and a passive dissolution pathway. The forced decomposition pathway involves high temperature decomposition of a magnesium chloride hydrate to produce magnesium hydroxide. The passive dissolution pathway involves dissolution of a mineral-oxide that forms the hydroxide-immediately and produces a chloride salt from the mineral-oxide; in this method, the production of two chemicals needed for capture (magnesium hydroxide) and precipitation (calcium) using the SkyCycle Process Sequence, are both made for use in that process, from the magnesium-chloride spontaneously produced by the precipitation process in that same SkyCycle sequence. These mineral oxides (CaO is the prime example for making both high-quality calcium-carbonates, but other Group-II metal oxides or oxides that form 1:1 ratios between metal and oxygen—e.g. MgO, or FeO, etc) including geologic minerals and industrial wastes, can be used in passive dissolution. Forced decomposition, by contrast, is not a spontaneous reaction sequence, requires larger amounts of energy (and carbon footprint if that energy is provided by carbonieferous sources), and requires multiple steps to accomplish the production of magnesium hydroxide and a working group-II chloride; specifically, the decomposition of the MgCl₂-salt occurs in two steps at different high-heat requirements, requires a condensation and production of HCl acid from condensation of the gascous HCl, and then requires a different dissolution process that uses the generated HCl to produce the CaCl₂ or XCl₂ from Ca/X-bearing materials, that are specifically not calcite (CaCO₃) or any carbonate source (wherein X is a metal or metalloid that is not calcium). By employing a combination of forced decomposition and passive dissolution pathways, the present inventor has developed a carbon dioxide capture and sequestration process with a significantly lower energy penalty than other carbon dioxide capture systems—with the added benefit that by operating a forced-decomposition system atop using available sources of metal-oxide to accomplish the reaction, which allows the process to be forced-to-remain in stoichiometric balance, and operate as an industrial process, will benefiting from the portion of low-energy-hydroxide/chloride production of the passive process, for all local/available minerals, oxides, and wastes (e.g. ash, slags, dusts) that can source that process.

In this regard, a method for capturing carbon dioxide from a gas stream and sequestering the carbon dioxide in the form of calcium carbonate is disclosed herein. In some aspects, the method comprises a first step of decomposing a magnesium chloride-containing material to form a first mixture comprising magnesium hydroxide and a second mixture comprising gaseous hydrogen chloride and water, a second step of combining calcium oxide with a magnesium chloride brine to produce a third mixture comprising magnesium hydroxide and calcium chloride, a third step of combining the first and third mixtures to provide a fourth mixture comprising magnesium hydroxide and calcium chloride, and a fourth step of contacting the fourth mixture with carbon dioxide to produce a product mixture comprising calcium carbonate and an aqueous solution of magnesium chloride. In some aspects, substantially no heat is provided as an input for the second step. In some aspects, the calcium carbonate is a solid precipitate and is separated from the aqueous solution of magnesium chloride. In some aspects, the aqueous solution of magnesium chloride is de-watered to provide a magnesium chloride-containing material. The aqueous solution of magnesium chloride can be de-watered to provide a magnesium chloride hydrate, for example.

In some aspects, the fourth mixture comprises approximately equal amounts of the magnesium hydroxide produced in the first step and the magnesium hydroxide produced in the second step. In some aspects, the magnesium hydroxide in the fourth mixture comprises a weight to weight ratio of magnesium hydroxide produced in the first step to magnesium hydroxide produced in the second step of any one of, less than, greater than, between, or any range thereof of 1:99, 2:98, 3:97, 4:96, 5:95, 6:94, 7:93; 8:92, 9:91, 10:90, 11:89, 12:88, 13:87, 14:86, 15:85, 16:84, 17:83, 18:82, 19:81, 20:80, 21:79, 22:78, 23:77, 24:76, 25:75, 26:74, 27:73, 28:72, 29:71, 30:70, 31:69, 32:68, 33:67, 34:66, 35:65, 36:64, 37:63, 38:62, 39:61 40:60, 41:59, 42:58, 43:57, 44:56, 45:55, 46:54, 47:53, 48:52, 49:51, 50:50, 51:49, 52:48, 53:47, 54:46, 55:45, 56:44, 57:43, 58:42, 59:41, 60:40, 61:39, 62:38, 63:37, 64:36, 65:35, 66:34, 67:33, 68:32, 69:31, 70:30, 71:29, 72:28, 73:27, 74:26, 75:25, 76:24, 77:23, 78:22, 79:21, 80:20, 81:19, 82:18, 83:17, 84:16, 85:15, 86:14, 87:13, 88:12, 89:11, 90:10, 91:9, 92:8, 93:7, 94:6, 95:5, 96:4, 97:3, 98:2, and 99:1.

In some aspects, the magnesium chloride-containing material is a magnesium chloride hydrate. The magnesium chloride hydrate can comprise magnesium chloride dodecahydrate, octahydrate, hexahydrate, tetrahydrate, dihydrate, and combinations thereof. In some aspects, the magnesium chloride hydrate comprises magnesium chloride tetrahydrate or magnesium chloride dihydrate. In some aspects, the magnesium chloride hydrate comprises 2.0-2.1 molar equivalents of waters of hydration. All of these forms of magnesium chloride can be used for both forced decomposition and passive dissolution methods to produce magnesium hydroxide and a corresponding chloride-of-the-metal-oxide used. Passive dissolution can be accomplished in brines of magnesium chloride; forced-decomposition can be accomplished only with the crystal forms of magnesium chloride. This elimination of the energy required to crystallize and decomposes the magnesium-chloride salt (as the passive dissolution steps are spontaneous and do not require these energies) is a major contributor to the low-energy combination of the two processes in supplied precursor chemicals to the SkyCycle process.

In some aspects, the first mixture comprises substantially no magnesium hydroxychloride. In some aspects, the first mixture comprises substantially no magnesium oxide. In some aspects, the magnesium chloride-containing material that is decomposed in the first step comprises at least a portion of the magnesium chloride produced in the fourth step.

In some aspects, a calcium-containing mineral or industrial material is contacted with an acid to produce calcium oxide. In some aspects, the calcium-containing mineral is selected from the group consisting of alite, jaffeite, perlite, vermiculite, diopside, tremolite, combinations thereof, or any other calcium-containing silicate mineral. In some embodiments the calcium-containing industrial material comprises masonry, concrete, steel furnace slag, bio-mass fuel production slag, waste coal fly ash, combinations thereof, and other mineral-containing waste materials. In some aspects, the acid is selected from the group consisting of hydrochloric acid, sulfuric acid, and nitric acid. In some aspects, at least a portion of the acid used to dissolve the calcium-containing mineral or industrial material is obtained from the decomposition of the magnesium chloride-containing material. In some aspects, the CaO produced from dissolution of a calcium-containing mineral or waste material is used as an input for the second step.

It is specifically contemplated that any limitation discussed with respect to one embodiment of the invention may apply to any other embodiment of the invention. Furthermore, any composition of the invention may be used in any method of the invention, and any method of the invention may be used to produce or to utilize any composition of the invention.

Other objects, features and advantages of the present invention will become apparent from the following detailed description. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### DETAILED DESCRIPTION

### A. Definitions

As used herein, the terms “carbonates” or “carbonate products” are generally defined as mineral components containing the carbonate group, [CO₃]²⁻. Thus, the terms encompass both carbonate/bicarbonate mixtures and species containing solely the carbonate ion. The terms “bicarbonates” and “bicarbonate products” are generally defined as mineral components containing the bicarbonate group, [HCO₃]¹⁻. Thus, the terms encompass both carbonate/bicarbonate mixtures and species containing solely the bicarbonate ion.

As used herein “Ca/Mg” signifies either Ca alone, Mg alone or a mixture of both Ca and Mg. The ratio of Ca to Mg may range from 0:100 to 100:0, including. e.g., 1:99, 2:98. 3:97. 4:96, 5:95, 6:94, 7:93; 8:92, 9:91, 10:90, 11:89, 12:88, 13:87, 14:86, 15:85, 16:84, 17:83, 18:82, 19:81, 20:80, 21:79, 22:78, 23:77, 24:76, 25:75, 26:74, 27:73, 28:72, 29:71, 30:70, 31:69. 32:68, 33:67, 34:66, 35:65, 36:64, 37:63, 38:62, 39:61 40:60, 41:59, 42:58, 43:57, 44:56, 45:55, 46:54, 47:53, 48:52, 49:51, 50:50, 51:49, 52:48, 53:47, 54:46, 55:45, 56:44, 57:43, 58:42, 59:41, 60:40, 61:39, 62:38, 63:37, 64:36, 65:35, 66:34, 67:33, 68:32, 69:31, 70:30, 71:29, 72:28, 73:27, 74:26, 75:25, 76:24, 77:23, 78:22, 79:21, 80:20, 81:19, 82:18, 83:17, 84:16, 85:15, 86:14, 87:13, 88:12, 89:11, 90:10, 91:9, 92:8, 93:7, 94:6, 95:5, 96:4, 97:3, 98:2, and 99:1. The symbols “Ca/Mg”, “MgₓCa₍₁₋ₓ₎” and “CaₓMg₍₁₋ₓ₎” are synonymous. The phrases “Group II” and “Group 2” are used interchangeably. A hydrate of magnesium chloride refers to any hydrate, including but not limited to hydrates that have 2, 4, 6, 8, or 12 equivalents of water per equivalent of magnesium chloride. Based on the context, the abbreviation “MW” either means molecular weight or megawatts. The abbreviation “PFD” is process flow diagram. The abbreviation “Q” is heat (or heat duty), and heat is a type of energy. This does not include any other types of energy.

As used herein, the term “capture” is used to refer generally to techniques or practices whose partial or whole effect is to remove carbon dioxide from point emissions. As used herein, the term “sequestration” is used to refer generally to techniques or practices whose partial or whole effect is to store captured carbon dioxide in some form so as to prevent its return to the atmosphere. Use of these terms does not exclude any form of the described embodiments from being considered capture and sequestration techniques.

The use of the word “a” or “an,” when used in conjunction with the term “comprising” in the claims and/or the specification may mean “one,” but it is also consistent with the meaning of “one or more.” “at least one,” and “one or more than one.”

Throughout this application, the term “about” is used to indicate that a value includes the inherent variation of error for the device, the method being employed to determine the value, or the variation that exists among the study subjects.

The terms “comprise,” “have” and “include” are open-ended linking verbs. Any forms or tenses of one or more of these verbs, such as “comprises,” “comprising.” “has.” “having.” “includes” and “including.” are also open-ended. For example, any method that “comprises,” “has” or “includes” one or more steps is not limited to possessing only those one or more steps and also covers other unlisted steps.

The above definitions supersede any conflicting definition in any reference that is incorporated by reference herein. The fact that certain terms are defined, however, should not be considered as indicative that any term that is undefined is indefinite. Rather, all terms used are believed to describe the invention in terms such that one of ordinary skill can appreciate the scope and practice the present invention.

Climate change is a defining issue of our time and humanity is at a defining moment. From shifting weather patterns that threaten food production, to rising sea levels that increase the risk of catastrophic flooding, the impacts of climate change are global in scope and unprecedented in scale. After more than a century and a half of industrialization, deforestation, and large scale agriculture, quantities of carbon dioxide in the atmosphere have risen to record levels not seen in three million years. Carbon capture and sequestration is widely seen as a critical strategy for limiting atmospheric emissions of carbon dioxide from power plants and other large industrial sources.

For the last 30 years, considerable efforts have been devoted to improve the technical feasibility of various carbon dioxide capture and sequestration approaches. The major drawback of carbon dioxide capture processes are high cost and the large energy requirements, and extensive research has been devoted to tackle the energy use, operational considerations, and product value and economics in order to attain propose profitable business models. One of the potential decarbonization technologies is mineral carbonation, which reproduces natural weathering with faster kinetics and enhanced conversion efficiency on an industrial scale.

While investigating mineral carbonation-based carbon capture systems, the present inventor developed a unique method that employs a combination of two sources and processes for obtaining magnesium hydroxide. The method employs a combination of passive dissolution and forced decomposition to provide magnesium hydroxide. The net result is a system that reduces the reliance on forced decomposition of magnesium chloride while maintaining the required chloride balance.

The carbon capture system disclosed herein employs a combination of a passive dissolution component and a forced decomposition component. In some embodiments, the passive dissolution component comprises contacting a mineral-containing material, preferably a waste material that contains leachable minerals, with acid and optionally water to leach mineral ion salts from the mineral material into a brine or slurry. Mineral ion salts from the brine or slurry can then be used as carbon dioxide-capture and/or carbon dioxide mineral storage reagents. In some embodiments, the waste material serves as a source of calcium cations, and in particular calcium oxide. In some embodiments, the mineral-containing material comprises calcium oxide. In some embodiments, the mineral-containing material is or includes a calcium-containing silicate mineral. In some embodiments, the mineral-containing material comprises alite, jaffeite, perlite, vermiculite, diopside, tremolite, a combination thereof, or any other calcium-containing silicate mineral. In some embodiments the mineral-containing material comprises masonry, concrete, steel furnace slag, bio-mass fuel production slag, waste coal fly ash, combinations thereof, and other mineral-containing waste materials. In some embodiments, calcium oxide obtained by the passive dissolution component can be combined with magnesium chloride to produce magnesium hydroxide and calcium chloride. The magnesium chloride can be obtained externally or internally from a different component of the carbon capture system. The reaction between calcium oxide obtained by passive dissolution and magnesium chloride is depicted below.

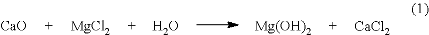

In some embodiments, the forced decomposition component comprises conductive heat-driven decomposition magnesium chloride. In some embodiments, a hydrate of magnesium chloride is employed, and any hydrated version of magnesium chloride may be used, including magnesium chloride dodecahydrate, octahydrate, hexahydrate, tetrahydrate, and dihydrate. In some embodiments, magnesium chloride dihydrate is selected as a starting material.

Magnesium chloride has an enthalpy of formation (Δ_{f}H° solid) of −601.58 KJ/mol. Magnesium hydroxide has a Δ_{f}H° solid of −924.66 KJ/mol. Because solid magnesium hydroxide exists in an energetic trough relative to the magnesium chloride starting material, heat can be collected from decomposition of magnesium chloride into the magnesium hydroxide. Collected heat can be internally harnessed, thereby contributing to the low energy penalty of the carbon dioxide capture and sequestration process. The enthalpy difference between the initial and final stage in the equation above is 0.0465 kWh, exclusive the enthalpy of exothermic HCl absorption into water, which is approximately 55 kJ/mol HCl. This includes formation of 2 moles of HCl, i.e. 110 kJ (0.031 kWh). The total is 0.0155 kWh. Every mole of magnesium hydroxide can react with one mole of CO₂. giving 0.0155/0.044=0.35 kWh/kg CO₂ as the minimum theoretical energy requirement.

In some embodiments, the magnesium chloride forced decomposition process is performed in a manner that averts formation of a magnesium hydroxychloride partial decomposition product. The magnesium chloride forced decomposition process is performed such that the decomposition reaction proceeds substantially to completion and the magnesium hydroxide product contains substantially no magnesium hydroxychloride.

In some aspects, the magnesium chloride forced decomposition process is performed in a manner that averts formation of a magnesium oxide decomposition product. The magnesium chloride forced decomposition process is performed such that the magnesium hydroxide product contains substantially no magnesium oxide. Magnesium oxide is a dehydrated form of magnesium hydroxide (Mg(OH)₂≡MgO+H₂O). Additional energy is required to remove the lone water molecule from magnesium hydroxide and produce magnesium oxide. Employing magnesium hydroxide as an intermediate and avoiding full dehydration of magnesium to magnesium oxide in the forced decomposition component can save energy and contribute to the low energy penalty of the carbon dioxide capture and sequestration process.

Magnesium hydroxide produced by forced decomposition of magnesium chloride can be combined with magnesium hydroxide produced from reaction magnesium chloride and calcium oxide, i.e., the passive dissolution product (reaction 1 above). The combined magnesium hydroxide (in solution) can then be used as an uptake fluid for absorption of carbon dioxide.

Combining magnesium hydroxide obtained from passive dissolution and magnesium hydroxide obtained by forced decomposition of magnesium chloride allows for a reduction in the amount of magnesium chloride that is decomposed. Reducing the amount of magnesium chloride that is decomposed reduces the total energy input required for magnesium chloride decomposition. Reducing the total energy input required for magnesium chloride decomposition contributes to the favorable thermodynamic energy penalty of the carbon capture process.

Combining magnesium hydroxide obtained from passive dissolution and magnesium hydroxide obtained by forced decomposition of magnesium chloride allows carbon dioxide capture and sequestration system to make use of mineral-containing materials that may otherwise be disposed as unwanted waste materials. Employing waste materials as a mineral source contributes to the eco-friendly nature of the carbon capture process.

Magnesium hydroxide obtained by a combination of passive dissolution and forced decomposition can be combined with water and exposed to flue gas in a bubble column. Energy is expended in compressing the flue gas, which includes approximately 12-19% carbon dioxide and additional components, with nitrogen as the primary additional component. At least a portion of carbon dioxide in the flue gas is absorbed into magnesium hydroxide solution, i.e., the uptake fluid, and initially forms magnesium carbonate. Calcium chloride present in the uptake fluid reacts with the magnesium carbonate through an “ion switch” reaction and forms calcium carbonate. The calcium carbonate spontaneously precipitates out of the solution, leaving magnesium chloride in solution. The calcium chloride solution in the uptake fluid is an indirect product of passive dissolution, however, additional calcium chloride can be added to the uptake fluid. Sourcing the calcium chloride from passive dissolution of an industrial waste material contributes to the eco-friendly nature of the carbon capture process. The solid, precipitated calcium carbonate (PCC) is then isolated to afford PCC and a magnesium chloride solution. Various methods may be used to separate the PCC from the solution. In one example, PCC and solution are separated by passive-hydrostatic pressure, i.e., natural draining with hydrostatic-head pressure filtration. The spontaneous formation of PCC is exothermic, and the heat released from this reaction may be recovered. Heat recovered from the calcium chloride formation “ion switch” reaction contributes to the low energy penalty of the carbon capture process. The recovered heat may be used internally to generate steam, thereby contributing to the favorable thermodynamic energy penalty of the carbon capture process.

The magnesium chloride solution can be de-watered to regenerate magnesium chloride or a hydrate thereof. In an exemplary de-watering process, waste heat from a co-operational plant or process can be used to drive the removal of water. In one embodiment, steam can be used to remove water from a solution of magnesium chloride. In this exemplary process, a two-step de-watering process is employed whereby at least a portion of water from the magnesium chloride solution is removed in a first step using a boiler/evaporator, and at least a portion of remaining water is removed in a second step using a spray-dryer. A boiler/evaporator may be employed to remove at least a portion of water in the magnesium chloride solution to produce an intermediate fluid having approximately three molar equivalents of waters of hydration. This intermediate fluid may then be transferred to a spray-dryer and heated to a temperature of ≥105° C. The fluid may then be flashed under pressure during which water/steam is separated as a vapor, and crystals of magnesium chloride hydrate having approximately 2.0-2.1 molar equivalents of waters of hydration are collected. Heat recovered from various segments of the carbon dioxide capture and sequestration process, or from a co-operational power plant can be used in the evaporating step or the spray-drying step to de-water the magnesium chloride solution. For example, steam generated from recovered heat can be used to heat a drying gas that is used to spray dry the magnesium chloride solution. Spray drying conditions can be adjusted to regenerate solid magnesium chloride having the desired degree of hydration. Regenerated magnesium chloride hydrate can then be transferred to the magnesium chloride forced decomposition reactor for decomposition.

In some embodiments, the carbon dioxide capture and sequestration process employs carbon dioxide that is harvested from a carbon dioxide emission source, such as from flue gas of a power generation facility. In some embodiments, heat is harvested from the carbon dioxide emission source flue gas. Traditionally, flue gas from a power generation facility is released into the atmosphere. The flue gas includes carbon dioxide, water in the form of water vapor or steam and additional gases. This waste flue gas can be harnessed in order to recover heat. A carbon dioxide capture and sequestration process as described herein can make use of external, co-generated heat in order to further reduce energy input requirements. The recovered heat can then be used to generate electricity, power a compressor, generate steam, and/or increase the temperature of steam. Excess heat from various high-heat components can be harnessed and channeled to heat-input or heat-absorbing (heat-negative) components. By linking various heat-surplus and heat-deficient process components, the reliance upon external heat sources is reduced. This reduces the process net energy penalty, but also reduces energy input costs, as the use of external energy sources is curtailed. Collectively, the carbon sequestration and heat-recovery and transfer components afford an efficient carbon dioxide capture and sequestration process with a remarkably low energy penalty.

1. A method for capturing CO₂ from a gas stream and sequestering the CO₂ in the form of CaCO₃, the method comprising:
(a) decomposing a MgCl₂-containing material to form a first mixture comprising Mg(OH)₂ and a second mixture comprising HCl and H₂O;
(b) combining CaO with a MgCl₂ brine to produce a third mixture comprising Mg(OH)₂ and CaCl₂;
(c) combining the first and third mixtures to provide a fourth mixture comprising Mg(OH)₂ and CaCl₂; and
(d) contacting the fourth mixture with CO₂ to produce a product mixture comprising CaCO₃ and an aqueous solution of MgCl₂.

2. The method of claim 1, wherein substantially no heat is provided as an input for step (b).

3. The method of claim 1, wherein the Mg(OH)₂ of step (c) comprises approximately equal amounts of the Mg(OH)₂ produced in step (a) and the Mg(OH)₂ produced in step (b).

4. The method of claim 1, wherein the MgCl₂-containing material is a MgCl₂ hydrate.

5. The method of claim 4, wherein the MgCl₂ hydrate comprises 2.0-2.1 molar equivalents of waters of hydration.

6. The method of claim 1, wherein the first product mixture comprises substantially no Mg(OH)Cl.

7. The method of claim 1, wherein the a MgCl2-containing material comprises at least a portion of the MgCl₂ produced in step (d).

8. The method of claim 1, further comprising dissolving a calcium-containing mineral or waste material with an acid to produce CaO.

9. The method of claim 8, wherein the CaO produced from dissolution of a calcium-containing mineral or waste material is used as an input for step (b)

10. The method of claim 8, wherein the acid is hydrochloric acid, nitric acid, or sulfuric acid.

11. The method of claim 9, wherein at least a portion of the hydrochloric acid is obtained from step (a).

12. The method of claim 8, wherein the calcium-containing mineral is selected from the group consisting of alite, jaffeite, perlite, vermiculite, diopside, tremolite, and combinations thereof.

13. The method of claim 8, wherein the calcium-containing waste material is selected from the group consisting of masonry, concrete, steel furnace slag, bio-mass fuel production slag, waste coal fly ash, and combinations thereof.
